(19) United States
(12) Patent Application Publication
(10) Pub. No.: US 2002/0059589 A1
(43) Pub. Date: May 16, 2002

(54) Apparatus and method for displaying broadcast information of television

(75) Inventor: Sang O. Park, Seoul (KR)

Correspondence Address: FLESHNER & KIM, LLP, P.O.Box 221200, Chantilly, VA, 20153-1200, US

(73) Assignee: LG ELECTRONICS INC.

(21) Appl. No.: 09/941,837

(22) Filed: Aug. 30, 2001

(30) Foreign Application Priority Data
Aug. 30, 2000 (KR) 2000-50760

(51) Int. Cl. H04N 7/025

(52) U.S. Cl. 725/35

(57) ABSTRACT

An apparatus and method for displaying broadcast information of a television is disclosed, which easily and swiftly provides information corresponding to a video image of a presently airing broadcast television program. The apparatus and method includes a broadcast service provider transmitting broadcast signals of each broadcast program including region information (information indicating a region whereby specific information exists) and specific information for each region, and a television receiver for receiving broadcast signals transmitted from the broadcast service provider, video processing the received broadcast signals and displaying them through a screen, and displaying specific information of a corresponding region when a user selects a certain region on the screen, thus increasing the convenience of the user.

### BACKGROUND OF THE INVENTION

1. Field of the Invention

The present invention relates generally to a television receiver, and more particularly to an apparatus and method for displaying broadcast information of a television.

2. Background of the Related Art

With the growth of an information age, the Internet, which is a communication media whereby information of a wide range of field including society, culture, finance, sports can be readily obtained, holds an important position in everyday life, and the possibility of its future development is considered to be infinite.

Accordingly, the number of personal computers has been rapidly increased as the media for using the Internet. Also, Internet television receivers (hereinafter referred to as Internet TVs) for enjoying both viewing of television broadcasting programs and an Internet service have been developed in accordance with the demands that television receivers should escape from unidirectional communication for simply receiving and viewing the television broadcasting programs and should be developed as bi-directional communication media capable of receiving and transmitting information. To cope with the growth of the information age, a steady development of the Internet TVs is required.

As shown in FIG. 1, a related art Internet television broadly includes an Internet module 10 for receiving and storing Internet information and converting the Internet information into video and audio signals, and a TV module 20 for outputting a general TV broadcasting program signal and the Internet information from the Internet module 10 through a TV screen and a loudspeaker.

First, the Internet module 10 consists of a network adapter 11 for connecting the Internet module to networks through a PSTN/LAN/CABLE, a memory unit 12 for storing therein basic programs and a wide range of information, a central processing unit (CPU) 13 for controlling transmission/reception of information through the network adapter 11 and conversion of audio/video signals, an input/output (I/O) unit 14 for inputting and outputting therethrough control information of the TV module 20 and the Internet module 10, an audio digital-to-analog (D/A) converter 15 for converting audio information among the Internet information input through the network adapter 11 into an analog audio signal to the TV module 20, a graphic processing unit 16 for graphic-processing video information among the Internet information input through the network adapter 11, and an NTSC encoder 17 for NTCS-encoding an output of the graphic processing unit 16 and outputting the encoded signal to the TV module 20.

In addition, the TV module 20 consists of a tuner/intermediate (IF) frequency unit 21 for selecting and IF-processing video/audio signals corresponding to a broadcasting channel selected by a user, a color picture tube (CPT) 24 and a loudspeaker 27 for outputting the video and audio signals, an audio/video (A/V) switching unit 22 for selecting and outputting either the video/audio signals selected by the tuner/IF unit 21 or the video/audio signals transmitted through the Internet module 10 in accordance with a switching signal, a memory unit 28 for storing basic programs and channel selection frequency according to the selected broadcasting channel, a microcomputer 29 for controlling respective elements of the TV module 20 including the A/V switching unit 22 in accordance with a TV/Internet mode selection command and various kinds of operation commands input through a remote controller 30, a deflection processing unit 25 for performing an electron beam deflecting operation of the CPT 24, a video processing unit 23 and an audio processing unit 26 for processing the video and audio signals output from the A/V switching unit 22 and outputting the processed video and audio signals through the CPT 24 and loudspeaker 21, respectively.

The method for driving the Internet television with the aforementioned structure will now be described.

First, when the power of the television is turned on, a channel chosen by the user is selected and the broadcasting signals are received. Then, the video/audio signals are processed through the TV module 20 and displayed through the CPT 24 and the loudspeaker 27, respectively.

Meanwhile, when the user wishes to use the Internet upon viewing the TV broadcasting program, the user selects an Internet mode as the present operation mode of the Internet TV by entering a TV/Internet mode selection key on the remote controller.

Then, the microcomputer 29 of the TV module 10 recognizes the Internet selection command, switches the A/V switching unit 22 to the Internet module 10, and transmits the Internet mode selection command to the Internet module 10 through the I/0 unit 14.

Subsequently, the CPU 13 of the Internet module 10 recognizes the Internet mode selection command, reads the Internet WEB page information stored in the memory unit 12, and controls the audio D/A conversion unit 15 and the graphic processing unit 16 to process information of the Internet WEB pages so that the processed information can be output through the TV module 20.

The information processed in the Internet module 10 is output to the CRT 24 and the loudspeaker 27 through the A/V switching unit 22, the video processing unit 23, and the audio processing unit of the TV module.

In this case, when the user selects one of the Internet WEB pages, the CPU 13 of the Internet module 10 recognizes the Internet selection command, reads the Internet WEB page with the network adapter 11, then controls the conversion process of the video/audio information, so that the processed information can be output through the TV module 20. Accordingly, the TV module processes the video/audio information to output the WEB page information through the CPT 24 and the loudspeaker 27.

In addition, a WEB page information screen is configured so that a user can acquire more specific information by using a signal inputting means such as a mouse. In other words, when the user moves the mouse to place a cursor within the screen to an item having further specific information, the cursor is either highlighted or changed in color. As the user clicks on the corresponding item once again, the screen shifts to a site marked with the corresponding specific information.

However, in the case of a general broadcasting television screen, the user can only view a corresponding image and cannot gain access to desired information through the television receiver.

For example, when the user comes across a character on television, a merchandise, or a place to visit, during a broadcasted program, the user usually desires to acquire related information such as the name of the TV character, the price of the merchandise or further detailed information, and the exact location of the place to visit. However, the current television receivers cannot directly provide a user with the desired information.

Therefore, the related art television receiver has the disadvantage of only displaying a general broadcast program and not providing further information corresponding to the program, thus, being unable to satisfy the user's desire to gain more information corresponding to the viewed program.

### SUMMARY OF THE INVENTION

Accordingly, the present invention is directed to an apparatus and method for displaying broadcast information of a television that substantially obviates one or more problems due to limitations and disadvantages of the related art.

An object of the present invention is to provide an apparatus and method for displaying broadcast information of a television whereby a user can gain, easily and swiftly, detailed information corresponding to a broadcasted television program directly from a television screen.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for displaying broadcast information of a television includes a broadcast service provider transmitting broadcast signals of each broadcast program including region information (information indicating a region whereby specific information exists) and specific information for each region, and a television receiver for receiving broadcast signals transmitted from the broadcast service provider, video processing the received broadcast signals and displaying them through a screen, and displaying specific information of a corresponding region when a user selects a certain region on the screen.

In another aspect of the present invention, a method for displaying broadcast information of a television including the steps of a broadcast service provider transmitting broadcast signals of each broadcast program including region information and specific information for each region, receiving through a television receiver broadcast signals transmitted from the broadcast service provider, video processing the received broadcast signals and displaying them through a screen, and storing the region information and specific information for each region among the broadcast signals, a user operating an indicating means to search a region on the screen and selecting a desired region, and displaying an video image of the region selected by the user or its corresponding specific information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments) of the invention and together with the description serve to explain the principle of the invention. In the drawings:

FIG. 1 is a block diagram illustrating a structure of the related art television receiver;

FIG. 2 is a block diagram illustrating a structure of a television receiver according to the present invention;

FIG. 3 is a flow chart illustrating a method for displaying broadcast information of television according to the present invention;

FIGS. 4 and 5 are examples illustrating a display of a screen divided into different regions;

FIG. 6 is an example illustrating a screen display when selecting region A of FIG. 5; and

FIG. 7 is an example illustrating a screen display when selecting region B of FIG. 5.

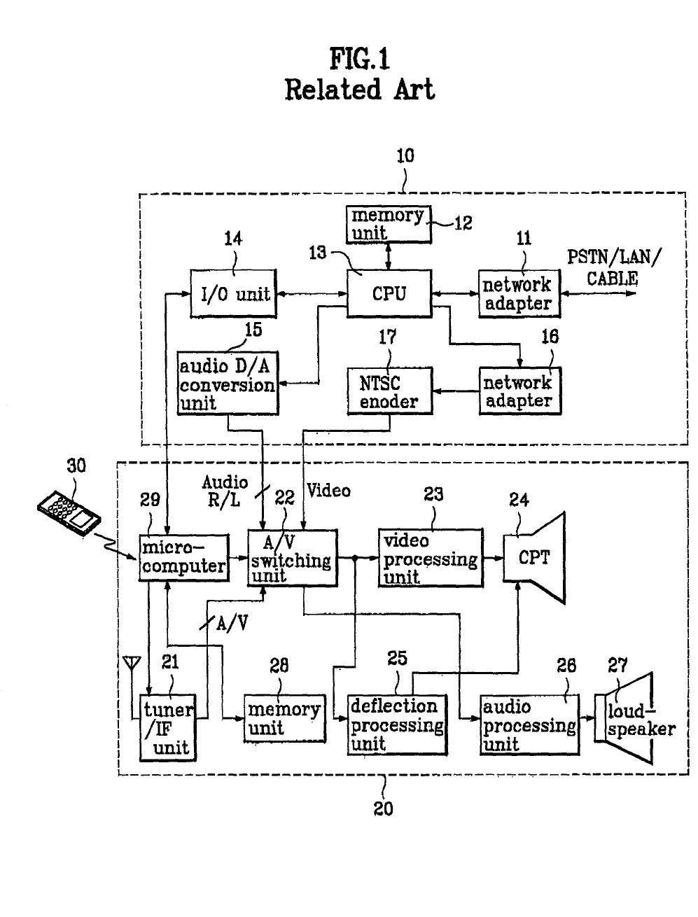

### DETAILED DESCRIPTION OF THE PREFERRED EMBODIMENTS

Reference will now be made in detail to the preferred embodiments of the present inventions examples of which are illustrated in the accompanying drawings.

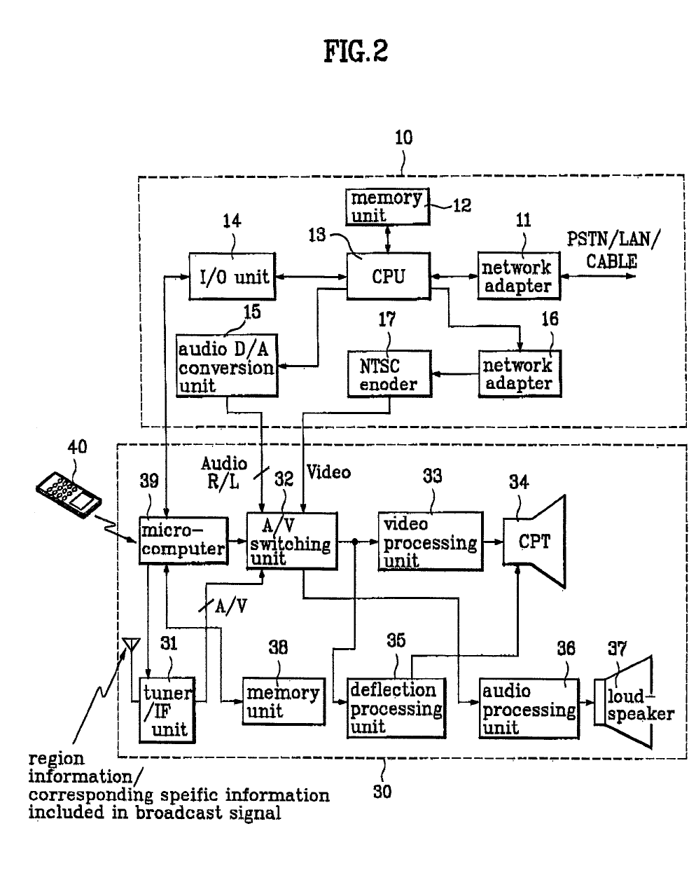

First, as shown in FIG. 2, an apparatus for displaying broadcast information of a television according to the present invention consists of a broadcast service provider transmitting broadcast signals of each broadcast program, which includes region information and specific information for each region, and a television receiver for extracting broadcast signals transmitted from the broadcast service provider, for storing the signals into a memory unit, and for controlling respective elements of the television in order to either directly display corresponding information of a region selected by a user or to display WEB information of an Internet site that corresponds to the region selected by the user.

The television receiver consists of a TV controlling means 40 for enabling the user to control TV functions and to select screen regions, a video processing unit 33 for video processing the broadcast signals and specific information corresponding to each region and for displaying the signals and information on the screen, a memory unit 38 for storing the region information and specific information corresponding to each region, and a microcomputer 39 for reading, from the memory unit 38, the specific information corresponding to the region of the screen selected by the user through the TV controlling means with reference to the region information and for outputting the information to the video processing unit 33.

In addition, the television receiver further includes an Internet module 10, which reads specific information to enable screen processing when the information relates to an Internet WEB site.

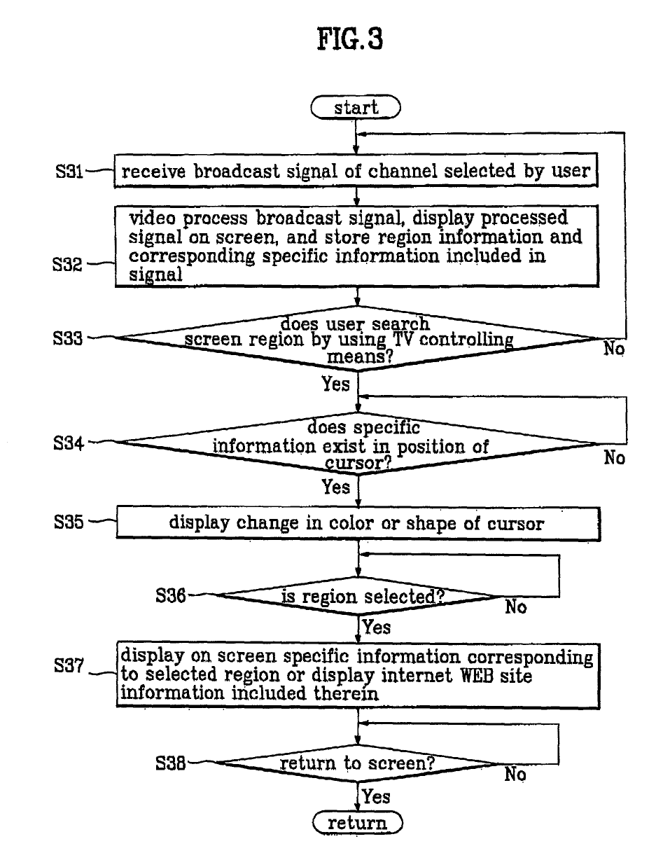

The method for displaying broadcast information of a television with the aforementioned structure will now be described with reference to FIG. 3 to FIG. 7.

First, a broadcast service provider transmits broadcast signals, which correspond to each broadcast program, including region information for identifying a region on the screen and also specific information. In other words, the signals include related video information of a corresponding region or a uniform resource locator CURL) of Internet WEB sites.

Therefore, the microcomputer 39 of the TV module 20 controls the tuner/IF 21 to receive the broadcast signal of the channel selected by the user (S31).

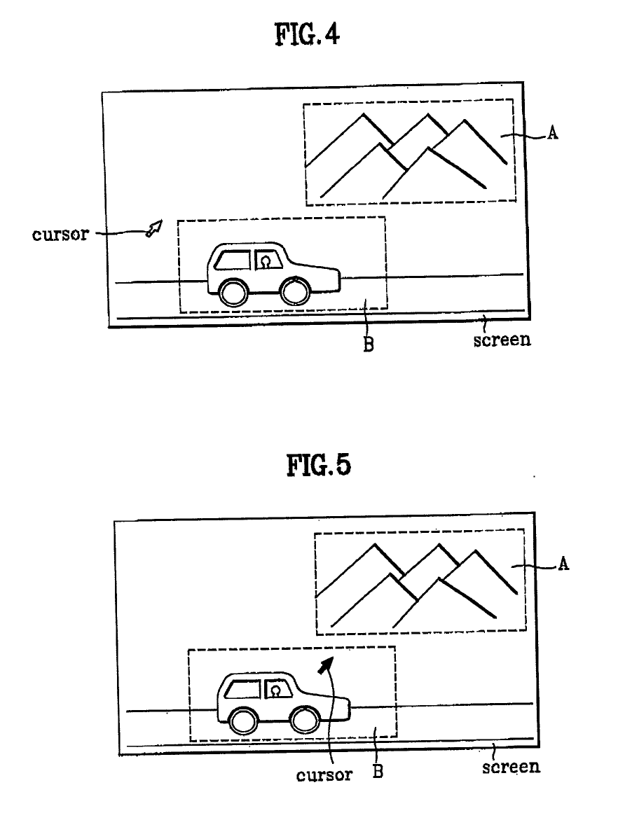

Subsequently, as shown in FIG. 4, the video signal among the broadcast signals is processed through the screen to display a video image with specific information existing within regions A and B. Then, the region information and specific information among the broadcast signals are extracted and stored into the memory unit 28 (S32).

Meanwhile, when the user wishes to gain information of certain video images among those displayed on the screen, the user uses a controlling means, such as a remote controller or a mouse, to search the screen and to place the cursor on the corresponding video image.

Therefore, the microcomputer 39 determines whether the user is searching the screen (S33). Then, by referring to the region information, the microcomputer 39 decides whether specific information corresponding to the region where the user placed the cursor exists (S34).

In addition, as shown in FIG. 5, in accordance with the aforementioned step (S34), when a specific information exists in the region pointed by the cursor, such as region A, the cursor changes either its shape or its color (S35) indicating the user that a specific information exists in the corresponding region.

Meanwhile, when the cursor is placed at a region that either does not correspond to the region information or does not have any specific information, then the cursor does not change in shape or color.

Subsequently, the microcomputer 39 determines whether the user acknowledges the presence of specific information according to the change in shape or color and whether the user. clicks on the mouse to select the corresponding region (S36).

Meanwhile, in the case of using a remote controller, when the user presses a certain button on the controller, the microcomputer 29 of the TV module 20 displays indexes, such as numbers or letters, which correspond to each region having specific information, using the region information stored within the memory unit 28. Therefore, the user selects a desired index.

When the user selects region A or region B, then the specific information of the corresponding region or the Internet WEB site information is displayed (S37).

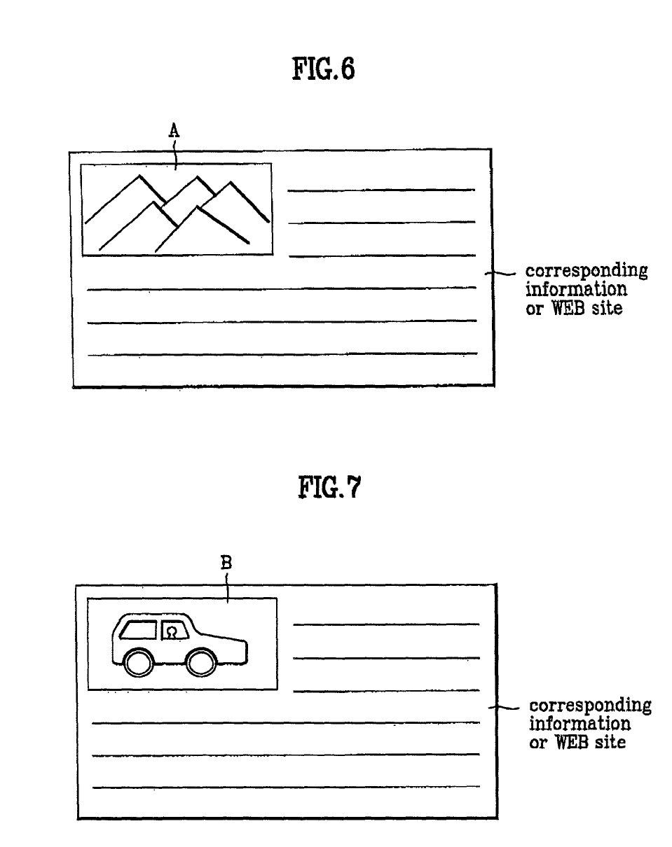

In other words, as shown in FIG. 6, a video image of region A is displayed on one side of the screen and the specific information stored within the memory unit 28, such as the name of the mountain displayed in region A, its location, means of transportation, and its special products, is displayed on the rest of the screen. If a corresponding Internet URL is present, the Internet module 10 is controlled so that a corresponding WEB site video image is displayed.

In addition, as shown in FIG. 7, when the user selects region B, a video image of region B is displayed on one side of the screen and the specific information stored in the memory unit 28, such as the name of the car displayed in region B, its specifications, its cost, and its purchase information, is displayed on the rest of the screen. If a corresponding Internet URL is present, the Internet module 10 is controlled so that a corresponding WEB site video image is displayed.

Meanwhile, the microcomputer 39 decides whether the user is inputting a return command in order to return to the original broadcasting screen (S38). Then, when the return command is input, for example, by pressing the buttons on the remote controller, the previously viewed broadcast program is displayed once again.

Therefore, with the displayed specific information or its corresponding Internet WEB site information, the user can gain the desired specific information and corresponding reference material and can even make purchase of a desired item.

The apparatus and method for displaying broadcast information of television is advantageous in that, among the video images on the screen, detailed information or related Internet WEB site information of a video image desired by the user is displayed in real-time, thereby increasing the user's convenience.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for displaying broadcast information of a television comprising:
a broadcast service provider transmitting broadcast signals of each broadcast program including region information (information indicating a region whereby specific information exists) and specific information for each region; and
a television receiver for receiving the broadcast signals transmitted from the broadcast service provider, video processing the received broadcast signals and displaying them through a screen, and displaying specific information of a corresponding region when a user selects a certain region on the screen.

2. The apparatus according to claim 1, wherein the television receiver includes:
a TV controlling means for enabling the user to control TV functions and to select screen regions;
a video processing unit for video processing the broadcast signals and specific information corresponding to each region and for displaying the signals and information on the screen;
a memory unit for storing the region information and specific information corresponding to each region; and
a microcomputer for reading, from the memory unit, the specific information corresponding to the region of the screen selected by the user through the TV controlling means with reference to the region information and for outputting the information to the video processing unit.

3. The apparatus according to claim 2, wherein the TV controlling means includes a direction key or a track ball for selecting the screen regions.

4. The apparatus according to claim 2, wherein the television receiver further includes an Internet module enabling WEB site information included in the specific information to be read and processed through the screen.

5. A method of displaying broadcast information of a television comprising the steps of:
a broadcast service provider transmitting broadcast signals of each broadcast program including region information and specific information for each region;
receiving through a television receiver the broadcast signals transmitted from the broadcast service provider, video processing the received broadcast signals and displaying them through a screen, and storing the region information and specific information for each region among the broadcast signals;
a user operating an indicating means to search a region on the screen and selecting a desired region; and
displaying a video image of the region selected by the user or its corresponding specific information.

6. The method according to claim 5, wherein the specific information for each region consists of at least one of video related information of a corresponding region and Internet WEB site URL.

7. The method according to claim 5, wherein the step of the user operating an indicating means to search a region on the screen and selecting a desired region includes the steps of:
moving a position of a cursor in accordance with the movement of the indicating means; and
changing a shape or color of the cursor, when specific information exists in the region of the screen where the cursor is positioned.

8. The method according to claim 5, wherein the step of the user operating an indicating means to search a region on the screen and selecting a desired region includes the steps of:
the user pressing a selection key on the indicating means to select the region;
displaying indexes on the regions defined by the region information among the regions of the screen; and
selecting among the indexes an index, which the user desires.

9. The method according to claim 5, wherein the step of displaying a video image of the region selected by the user or its corresponding specific information includes the step of:
displaying a video image of a region selected by the user on one side of the screen and displaying corresponding video related information on the rest of the screen.

10. The method according to claim 5, wherein the step of displaying a video image of the region selected by the user or its corresponding specific information includes the step of:
connecting to an Internet WEB site corresponding to the video image of the selected region and displaying a corresponding screen image.
